(19) United States
(12) Patent Application Publication
(10) Pub. No.: US 2026/0131888 A1
(43) Pub. Date: May 14, 2026

(54) Method, System and Storage Medium for Controlling Vertical Take-Off Process of Aircraft

(71) Applicant: Wuhan Xuantian Feiche Aviation Technology Co., Ltd., Wuhan City (CN)

(72) Inventor: Fengnian TIAN, Wuhan City (CN)

(21) Appl. No.: 19/365,076

(22) Filed: Oct. 21, 2025

(30) Foreign Application Priority Data
Nov. 14, 2024 (CN) 202411627811.4

(51) Int. Cl. B64C 29/00; B64F 5/60

(52) U.S. Cl. CPC B64C 29/0033; B64F 5/60

(57) ABSTRACT

Method and system, and storage medium for controlling vertical take-off process of aircraft are provided. By precise control of tilt-rotor rotational speed and optimization of tilting process, a smooth transition of the aircraft from vertical take-off to forward flight is achieved; during aircraft transition process, the tilt-rotor rotational speed is reduced to prevent aerodynamic disturbances generated by the tilt-rotors from affecting wings and airframe, thereby improving flight comfort and safety; moreover, by relying on propulsion propellers to maintain flight speed and altitude of the aircraft during transition, the flight control system design is simplified, and the complexity and redundancy of the control system are reduced; and the aircraft using this method for controlling take-off process has higher safety, stability, and comfort, and is suitable for various application scenarios, including the fields of urban air mobility and emergency rescue.

### CROSS-REFERENCE TO RELATED APPLICATION

This patent application claims the benefit and priority of Chinese Patent Application No. 202411627811.4 filed with the China National Intellectual Property Administration on Nov. 14, 2024, the disclosure of which is incorporated by reference herein in its entirety as part of the present application.

### TECHNICAL FIELD

The present disclosure relates to the technical field of aircraft control, and in particular to a method, a system, and a storage medium for controlling a vertical take-off process of an aircraft.

### BACKGROUND

Vertical Take-Off and Landing (VTOL) aircraft have gained widespread attention in recent years across multiple fields such as civil, military, and logistics fields, especially urban air traffic and emergency rescue, in which VTOL technology is expected to address problems such as traffic congestion and rapid response. Since VTOL aircraft can achieve vertical take-off and landing without a runway, they possess significant advantages in scenarios with complex terrain or limited space. Research on such aircraft is being conducted worldwide with broad application prospects, especially in personal transportation and unmanned aerial vehicle logistics. However, existing vertical take-off and landing technologies still face challenges in various aspects, including efficiency and control complexity. VTOL aircraft are generally classified into three configuration types: multi-rotor, compound-wing, and tilt-rotor.

Compound-wing aircraft typically has two independently operating drive systems including: a lift rotor group and thrust propellers. The lift rotor group is responsible for the vertical take-off and landing of the aircraft. After the aircraft leaves the ground, the thrust propellers are responsible for propelling the aircraft forward. When the aircraft is flying under the propulsion of the thrust propellers, lift propellers shut down and do no work. A representative example of compound-wing aircraft is, for example, a helicopter described in Chinese patent application CN 116374170 A, which uses the two systems (i.e., the lift rotor group and the thrust propellers) for vertical take-off and landing, and forward flight, respectively. However, the main defect of this design is that the lift rotor group no longer performs work during the horizontal flight phase, becoming “dead weight” that significantly impairs flight efficiency and range.

A tilt-rotor aircraft has a set of rotors capable of tilting at different angles. Before take-off, the tilt-rotor blades are essentially parallel to a horizontal plane. When the aircraft is ready for take-off, the tilt-rotors gradually increase their rotational speed to generate lift, enabling the aircraft to take off vertically. After the aircraft leaves the ground, the tilt-rotor blades gradually tilt from the position parallel to the horizontal plane to one perpendicular to the horizontal plane. During this process, the lift generated by the tilt-rotors is partially converted into thrust for propelling the aircraft forward, until all the lift is used for propelling the aircraft forward. Although the tilt-rotor configuration simplifies system design, airflow generated during its transition process imposes extremely high requirements on aircraft control. For example, for a tilt-rotor multi-rotor aircraft in Chinese patent application CN 105905291 A, the aerodynamic disturbances from tilt-rotors affect its airframe, thereby reducing flight comfort and safety.

The existing tilt control strategies have the following problems: (1) during tilting, the strong aerodynamic coupling effect between rotors, wings, and airframe results in severe aerodynamic interference; and (2) the control of a tilt transition process is highly challenging. In the tilt-rotor aircraft, the intense airflow disturbances generated during tilting often affect the stability of the aircraft. For example, additional aerodynamic interference on the wings and airframe increases the complexity of a flight control system, thereby enhancing the difficulty of design and debugging. This not only reduces passenger comfort, but also raises requirements for the redundancy and safety of the flight control system. Therefore, existing technologies are difficult to meet the requirements for safe control during smooth flight and transition, and further improvements are required.

### SUMMARY

The present disclosure provides a method, a system and a storage medium for controlling a vertical take-off process of an aircraft, which can solve the problems of poor stability, low comfort, and complex flight control existing in take-off, landing, and transition processes of existing tilt-rotor aircraft. By optimizing tilt-rotor deceleration control and tilting process, the control method significantly improves the aircraft performance.

To solve the above problems, the technical solutions provided by the present disclosure are as follows.

The embodiment of the present disclosure provide a method for controlling a vertical take-off process of an aircraft, including:
step S1: provision of an aircraft, where a control system and sensors for monitoring an aircraft status in real time are provided in the aircraft, and propulsion propellers and a plurality of tilt-rotors are provided on the aircraft; and
aircraft take-off preparation, where, in an aircraft take-off preparation phase, blades of the tilt-rotors are parallel to a horizontal plane, and the tilt-rotors are in a standby state; and when the aircraft is located at a take-off location, the control system enters a ready state, and the aircraft completes all pre-take-off preparation work;
step S2: tilt-rotor activation with rotational speed gradually increasing, where, when the aircraft starts to take off, the tilt-rotors are gradually activated, and a rotational speed of the tilt-rotors is gradually increased from a low speed to a speed that generates sufficient lift to lift the aircraft off ground; in this process, rotational speed control of the tilt-rotors is a key parameter, and the sensors monitor the aircraft status in real time to enable the rotational speed of the tilt-rotors to adapt to aircraft weight and environmental conditions to provide sufficient vertical lift, and the tilt-rotors are parallel to the horizontal plane, or tilted at a first preset angle relative to the horizontal plane;
step S3: aircraft lift-off detection, where when the rotational speed of the tilt-rotors reaches a preset value, the lift generated by the aircraft exceeds the aircraft weight, and the aircraft starts to rise vertically, the sensors for monitoring the aircraft status monitor whether the aircraft has completely left the ground in real time, and after confirmation of a lift-off state, the aircraft continues to rise at a stable speed;
step S4: propulsion propeller activation with rotational speed gradually increasing, where, after the aircraft leaves the ground and rises to a certain altitude, the propulsion propellers are activated for gradually increasing a speed of the aircraft in a forward direction to transition the aircraft gradually from a stationary state to a state with a certain flight speed; where increase in the rotational speed of the propulsion propellers is coordinated with a flight altitude of the aircraft, changes in the rotational speed of the tilt-rotors, and overall attitude of the aircraft to ensure stability of a flight attitude of the aircraft;
step S5: aircraft airspeed detection, where, after the propulsion propellers start to provide thrust, the aircraft enters an airspeed monitoring phase; the control system detects an airspeed of the aircraft by the sensors; when the airspeed of the aircraft reaches a set critical value, i.e., greater than a stall speed, the control system proceeds to a next operation, and the aircraft already has obtained a certain flight capability;
step S6: tilt-rotor deceleration, where after the aircraft reaches a certain airspeed, the control system starts to gradually reduce the rotational speed of the tilt-rotors, such that the rotational speed of the tilt-rotors gradually decreases to a preset safe level, ensuring that during upcoming tilting, airflow interference from the tilt-rotors to the aircraft is minimized, effectively avoiding airflow impact on wings and an airframe from high-speed rotation of conventional tilt-rotors, and thus improving flight comfort;
step S7: tilt-rotor tilting, where, after the tilt-rotors decelerate to a specified rotational speed, the tilt rotors start to perform a gradual tilting operation, such that the blades of the tilt-rotors gradually change from being parallel to the horizontal plane to being tilted at a second preset angle relative to a vertical direction of the horizontal plane; and during tilting, the tilt-rotors do no work relative to the aircraft; and by precise angle control and rotational speed adjustment, tilting transition of the tilt-rotors has minimal impact on the overall aerodynamic characteristics of the aircraft, ensuring a stable flight process;
step S8: further increase in tilt-rotor rotational speed, where after the tilt-rotors complete tilting, and thus the blades of the tilt-rotors have been tilted to the second preset angle relative to a direction perpendicular to the horizontal plane, function of the tilt-rotors changes from providing vertical lift to auxiliary propulsion; and the control system gradually increases the rotational speed of the tilt-rotors again, enabling the tilt-rotors to work together with the propulsion propellers to provide flight thrust in the forward direction, thereby increasing the flight speed and efficiency of the aircraft; and
step S9: aircraft entering a flight mode, where after the tilt-rotors are re-accelerated to the specified rotational speed, the aircraft fully enters a flight state, the tilt-rotors and the propulsion propellers jointly function within a propulsion system of the aircraft to provide sufficient flight thrust in the forward direction, enabling the aircraft to travel at a stable speed and altitude, and the sensors continue to monitor the flight state of the aircraft to ensure safety and stability of the aircraft.

In an optional embodiment of the present disclosure, in step S1, an on-board computer performs self-test on an actuator and the sensors, and the sensors include an inertial measurement unit, a barometric pressure sensor, a temperature sensor, a speed sensor, a fuel quantity sensor, a navigation sensor, a radar and laser sensor, an optical sensor, a strain sensor, an altitude sensor, and a load sensor.

In an optional embodiment of the present disclosure, in step S2, the rotational speed of each tilt-rotor is measured by a built-in rotational speed sensor of a drive motor, the rotational speed of the tilt-rotor gradually increases according to a preset curve, and the first preset angle ranges from −30° to 30°.

In an optional embodiment of the present disclosure, in step S3, the control system determines the lift-off state of the aircraft by feedback from the altitude sensor and the load sensor, and when a value measured by the altitude sensor exceeds a certain threshold, or a contact force detected by the load sensor decreases to zero, the control system determines that the aircraft has lifted off the ground; conversely, the control system controls the rotational speed of the tilt-rotors to further increase, enabling the aircraft to obtain more lift until the aircraft leaves the ground.

In an optional embodiment of the present disclosure, in step S4, the rotational speed of the propulsion propellers gradually increases according to a preset curve.

In an optional embodiment of the present disclosure, in step S4, during the propulsion propeller activation with rotational speed gradually increasing, the propulsion propellers are activated before the aircraft leaves the ground.

In an optional embodiment of the present disclosure, in step S7, the second preset angle ranges from −30° to 30°, and in step S9, when the aircraft enters the horizontal flight mode, the aircraft flies forward relying solely on the power of the tilt-rotors or the propulsion propellers.

In an optional embodiment of the present disclosure, step S3 further includes: a wind energy suction pump and an air storage tank at a bottom of the aircraft, where air is continuously jetted downward through an air jet of the air storage tank to provide lift support for the vertical take-off of the aircraft.

According to the method for controlling the vertical take-off process of the aircraft according to the above-described embodiments, the embodiment of the present disclosure further provide a system for controlling a vertical take-off process of an aircraft. The system includes:
an aircraft take-off preparation module, configured such that in an aircraft take-off preparation phase, blades of tilt-rotors are parallel to a horizontal plane, and the tilt-rotors are in a standby state; and when the aircraft is located at a take-off location, a control system enters a ready state, and the aircraft completes all pre-take-off preparation work;
a tilt-rotor activation and rotational speed gradual increase module, configured such that when the aircraft starts to take off, the tilt-rotors are gradually activated, and a rotational speed of the tilt-rotors is gradually increased from a low speed to a speed that generates sufficient lift to lift the aircraft off ground; in this process, rotational speed control of the tilt-rotors is a key parameter, and sensors monitor an aircraft status in real time to enable the rotational speed of the tilt-rotors to adapt to aircraft weight and environmental conditions to provide sufficient vertical lift, and the tilt-rotors are parallel to the horizontal plane, or tilted at a first preset angle relative to the horizontal plane, and the first preset angle ranging from −30° to 30°;
an aircraft lift-off detection module, configured such that when the rotational speed of the tilt-rotors reaches a preset value, the lift generated by the aircraft exceeds the aircraft weight, and the aircraft starts to rise vertically, the sensors for monitoring the aircraft status monitor, whether the aircraft has completely left the ground in real time, and after confirmation of a lift-off state, the aircraft continues to rise at a stable speed;
a propulsion propeller activation and rotational speed gradual increase module, configured such that after the aircraft leaves the ground and rises to a certain altitude, propulsion propellers are activated for gradually increasing a speed of the aircraft in a forward direction to transition the aircraft gradually from a stationary state to a state with a certain flight speed; where increase in the rotational speed of the propulsion propellers is coordinated with a flight altitude of the aircraft, changes in the rotational speed of the tilt-rotors, and overall attitude of the aircraft to ensure stability of a flight attitude of the aircraft;
an aircraft airspeed detection module, configured such that after the propulsion propellers start to provide thrust and the aircraft enters an airspeed monitoring phase, the control system detects an airspeed of the aircraft by the sensors; when the airspeed of the aircraft reaches a set critical value, i.e., greater than a stall speed, the control system proceeds to a next operation, and the aircraft already has obtained a certain flight capability;
a tilt-rotor deceleration module, configured such that after the aircraft reaches a certain airspeed, the control system starts gradually reduces the rotational speed of the tilt-rotors, such that the rotational speed of the tilt-rotors gradually decreases to a preset safe level, ensuring that during upcoming tilting, airflow interference from the tilt-rotors to the aircraft is minimized, effectively avoiding airflow impact on wings and an airframe from high-speed rotation of conventional tilt-rotors, and thus improving flight comfort;
a tilt-rotor tilting module, configured such that after the tilt-rotors decelerate to a specified rotational speed, the tilt rotors start to perform a gradual tilting operation; such that the blades of the tilt-rotors gradually change from being parallel to the horizontal plane to being tilted at a second preset angle relative to a vertical direction of the horizontal plane, the second preset angle ranging from −30° to 30°; and during tilting, the tilt-rotors do no work relative to the aircraft; and by precise angle control and rotational speed adjustment, tilting transition of the tilt-rotors has minimal impact on the overall aerodynamic characteristics of the aircraft, ensuring a stable flight process;
a tilt-rotor rotational speed re-increasing module, configured such that after the tilt-rotors complete tilting, and thus the blades of the tilt-rotors have been tilted to the second preset angle relative to a direction perpendicular to the horizontal plane, function of the tilt-rotors changes from providing vertical lift to auxiliary propulsion; and the control system gradually increases the rotational speed of the tilt-rotors again, enabling the tilt-rotors to work together with the propulsion propellers to provide flight thrust in the forward direction, thereby increasing the flight speed and efficiency of the aircraft; and
an aircraft entering flight mode module, configured such that after the tilt-rotors are re-accelerated to the specified rotational speed, and the aircraft fully enters a flight state, the tilt-rotors and the propulsion propellers jointly function within a propulsion system of the aircraft to provide sufficient flight thrust in the forward direction, enabling the aircraft to travel at a stable speed and altitude, and the sensors continue to monitor the flight state of the aircraft to ensure safety and stability of the aircraft.

The system for controlling the vertical take-off process of the aircraft further includes an auxiliary lift module including a wind energy suction pump and an air storage tank arranged at a bottom of the aircraft, and where air is continuously jetted downward through an air jet of the air storage tank to provide lift support for the vertical landing of the aircraft.

The embodiments of the present disclosure further provide a computer-readable storage medium having a computer program stored thereon. The computer program, when executed by a processor, implements steps of the method for controlling the vertical take-off process of the aircraft according to the above-described embodiments.

The embodiments of the present disclosure provide a method, a system, and a storage medium for controlling a vertical take-off process of an aircraft, which have the following beneficial effects.
(1) The present disclosure improves flight comfort. During transition of existing tilt-rotor aircraft, rotors typically need to maintain rotational speed and increase pitch, continuously outputting power to the aircraft to generate sufficient lift to balance the aircraft's own weight and forward flight power. In this case, the airflow disturbances caused by the high-speed rotation of the tilt-rotors easily affect an airframe and wings of the aircraft, leading to flight instability, which in turn affects passenger comfort. The present disclosure gradually reduces the rotational speed of the tilt-rotors after the aircraft reaches a certain airspeed, reducing the tilt-rotors'interference with airflow, making the tilt transition process smoother, thereby significantly improving riding comfort.
(2) The present disclosure simplifies the design of the flight control system. In the prior art, tilt-rotors need to maintain both the flight altitude and propulsion speed of the aircraft during transition, which increases the design difficulty of the flight control system and easily leads to system redundancy problems. In contrast, the present disclosure relies on the propulsion propellers to provide thrust for the aircraft during transition, maintaining the speed and altitude of the aircraft. The tilt-rotors maintain a low speed during tilting and do not interfere with the attitude control of the aircraft, simplifying the design of the flight control system, reducing the need for control system redundancy, and lowering system complexity.
(3) The present disclosure improves the energy efficiency of the aircraft. In existing aircraft with a compound-wing configuration, lift rotors stop working during a horizontal flight phase and become “dead weight”, significantly reducing the energy efficiency of the aircraft. In the present disclosure, however, the tilt-rotors further increase the rotational speed after completing the tilting process and participate in propulsion during a horizontal flight phase, preventing the rotors from becoming a burden. This design improves the overall energy utilization efficiency of the aircraft, extends its endurance capability, and is particularly suitable for long-distance flight missions.
(4) The present disclosure has a simple structure easy to implement. The control method of the present disclosure reasonably designs the deceleration, tilting, and re-acceleration processes of the tilt-rotors without introducing additional complex structures or new assemblies, and can be implemented on the basis of the existing tilt-rotor aircraft structure. This not only reduces the manufacturing and maintenance costs of the aircraft but also reduces the failure rate and improves system reliability.

### BRIEF DESCRIPTION OF THE DRAWINGS

To describe the technical solutions in embodiments or in prior art more clearly, the following briefly describes the accompanying drawings required for describing the embodiments or prior art. Apparently, the accompanying drawings in the following description merely show some embodiments of the present disclosure, and those of ordinary skill in the art can still derive other drawings from these accompanying drawings without any inventive effort.

FIG. 1 shows a schematic structural diagram of an aircraft according to an embodiment of the present application;

FIG. 2 shows a flow chart of a method for controlling a vertical take-off process of an aircraft according to an embodiment of the present application; and

FIG. 3 shows a schematic diagram of a storage medium of a system for controlling a vertical take-off process of an aircraft according to an embodiment of the present application.

### DETAILED DESCRIPTION OF THE EMBODIMENTS

The technical solutions in embodiments of the present application would be clearly and completely described below with reference to the drawings in the embodiments of the present application. Apparently, the described embodiments are merely some rather than all of the embodiments of the present application. All other embodiments obtained by those skilled in the art based on the embodiments of the present application without any inventive effort should fall within the protection scope of the present application.

The present disclosure provides a method for controlling a vertical take-off process of an aircraft, which is intended to solve the problems such as aerodynamic disturbances, flight control complexity, and flight safety of existing tilt-rotor aircraft during transition. This take-off and landing process control method ensures smoother, safer, and more efficient transition between vertical take-off/landing and horizontal flight of the aircraft by reasonable rotor rotational speed control and tilt process design. The specific technical solution is as follows.

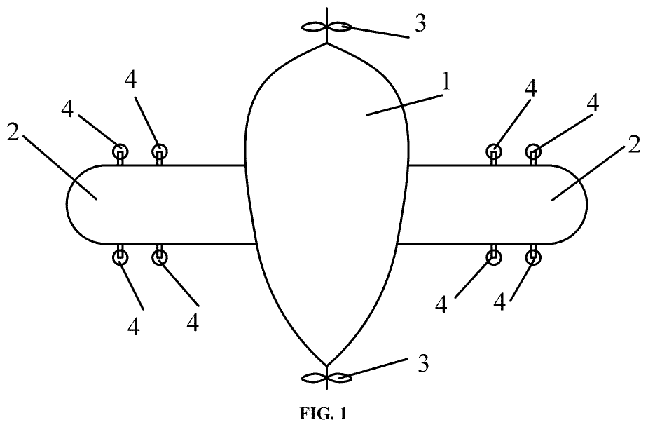

As shown in FIG. 1, an airframe of an aircraft 1 can be provided with a propulsion propeller 3 at its front and/or rear, and a plurality of tilt-rotors 4 are symmetrically arranged on wings 2 at both sides of the aircraft 1. In other embodiments, the aircraft can be provided with a plurality of tilt-rotors at the front and/or rear of its airframe with propulsion propellers symmetrically arranged on the both wings. The propulsion propellers and the tilt-rotors may be mounted according to specific conditions and requirements, which is not specifically limited here.

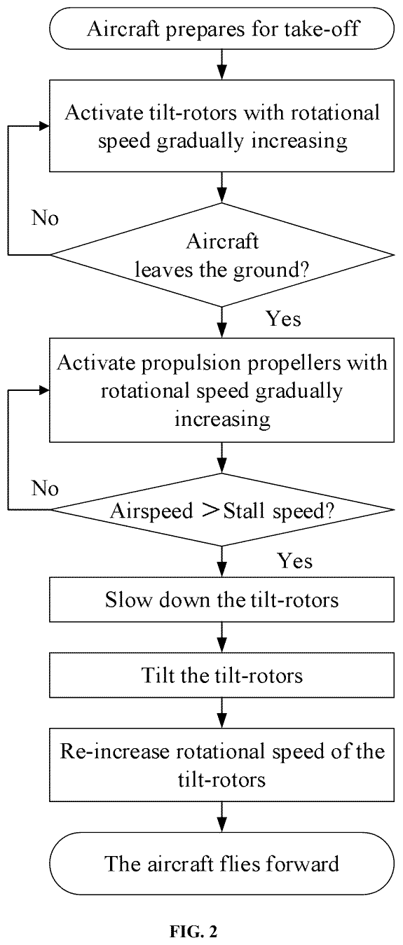

As shown in FIG. 2, the embodiment according to the present disclosure provides a method for controlling a vertical take-off process of an aircraft, including the following steps:
step S1: an aircraft is provided, where a control system and sensors for monitoring an aircraft status in real time are provided in the aircraft, and propulsion propellers and a plurality of tilt-rotors are provided on the aircraft; and
aircraft take-off preparation: in an aircraft take-off preparation phase, blades of the tilt-rotors are parallel to a horizontal plane, and the tilt-rotors are in a standby state; and when the aircraft is located at a take-off location, the control system enters a ready state, and the aircraft completes all pre-take-off preparation work;
step S2: tilt-rotor activation with rotational speed gradually increasing, where when the aircraft starts to take off, the tilt-rotors are gradually activated, and a rotational speed of the tilt-rotors is gradually increased from a low speed to a speed that generates sufficient lift to lift the aircraft off ground; in this process, rotational speed control of the tilt-rotors is a key parameter, and the sensors monitor the aircraft status in real time to enable the rotational speed of the tilt-rotors to adapt to aircraft weight and environmental conditions to provide sufficient vertical lift, and the tilt-rotors are parallel to the horizontal plane, or tilted at a first preset angle relative to the horizontal plane;
step S3: aircraft lift-off detection, where when the rotational speed of the tilt-rotors reaches a preset value, the lift generated by the aircraft exceeds the aircraft weight, and the aircraft starts to rise vertically, the sensors for monitoring the aircraft status monitor whether the aircraft has completely left the ground in real time, and after confirmation of a lift-off state, the aircraft continues to rise at a stable speed;
step S4: propulsion propeller activation with rotational speed gradually increasing, where after the aircraft leaves the ground and rises to a certain altitude, the propulsion propellers are activated for gradually increasing a speed of the aircraft in a forward direction to transition the aircraft gradually from a stationary state to a state with a certain flight speed; where increase in the rotational speed of the propulsion propellers is coordinated with a flight altitude of the aircraft, changes in the rotational speed of the tilt-rotors, and overall attitude of the aircraft to ensure stability of a flight attitude of the aircraft;
step S5: aircraft airspeed detection, where after the propulsion propellers start to provide thrust, the aircraft enters an airspeed monitoring phase; the control system detects an airspeed of the aircraft by the sensors; when the airspeed of the aircraft reaches a set critical value, i.e., greater than a stall speed, the control system proceeds to a next operation, and the aircraft already has obtained a certain flight capability;
step S6: tilt-rotor deceleration, where after the aircraft reaches a certain airspeed, the control system starts to gradually reduce the rotational speed of the tilt-rotors, such that the rotational speed of the tilt-rotors gradually decreases to a preset safe level, ensuring that during upcoming tilting, airflow interference from the tilt-rotors to the aircraft is minimized, effectively avoiding airflow impact on wings and an airframe from high-speed rotation of conventional tilt-rotors, and thus improving flight comfort;
step S7: tilt-rotor tilting, where after decelerating to a specified rotational speed, the tilt-rotors start to perform a gradual tilting operation, such that the blades of the tilt-rotors gradually change from being parallel to the horizontal plane to being tilted at a second preset angle relative to a vertical direction of the horizontal plane; and during tilting, the tilt-rotors do no work relative to the aircraft; and by precise angle control and rotational speed adjustment, tilting transition of the tilt-rotors has minimal impact on the overall aerodynamic characteristics of the aircraft, ensuring a stable flight process;
step S8: further increase in tilt-rotor rotational speed, where after the tilt-rotors complete tilting, and thus the blades of the tilt-rotors have been tilted to the second preset angle relative to a direction perpendicular to the horizontal plane, function of the tilt-rotors changes from providing vertical lift to auxiliary propulsion; and the control system gradually increases the rotational speed of the tilt-rotors again, enabling the tilt-rotors to work together with the propulsion propellers to provide flight thrust in the forward direction, thereby increasing the flight speed and efficiency of the aircraft; and
step S9: aircraft entering a flight mode, where after the tilt-rotors are re-accelerated to the specified rotational speed, the aircraft fully enters a flight state, the tilt-rotors and the propulsion propellers jointly function within a propulsion system of the aircraft to provide sufficient flight thrust in the forward direction, enabling the aircraft to travel at a stable speed and altitude, and the sensors continue to monitor the flight state of the aircraft to ensure safety and stability of the aircraft.

Preferably, the first preset angle in step S2 ranges from −30° to 30°. In step S4, during propulsion propeller activation and rotational speed gradual increase, the propulsion propellers may be activated before the aircraft leaves the ground, provided that the flight outcome is not affected. In step S6, during deceleration of the tilt-rotors, the tilt-rotors do not necessarily need to decelerate to stop, but can operate at a low speed; alternatively, the tilt-rotors may not decelerate at all. In this case, since both the tilt-rotors and the propulsion propellers require power, the total power demand increases. The second preset angle in step S7 ranges from −30° to 30°. In step S9, when the aircraft enters the horizontal flight mode, the aircraft flies forward relying solely on the power of the tilt-rotors or the propulsion propellers, and the power apparatus that does not generate thrust may cease operation. Step S3 further includes: providing a wind energy suction pump and an air storage tank at a bottom of the aircraft, and continuously jetting air downward through an air jet of the air storage tank to provide lift support for the vertical take-off of the aircraft.

The sensors for monitoring the aircraft status in real time in step S1 mainly include: an inertial measurement unit (IMU) including an accelerometer and a gyroscope to measure an acceleration, angular velocity, and attitude of the aircraft; a barometric pressure sensor to measure altitude and atmospheric pressure to help the aircraft maintain the correct altitude; a temperature sensor to monitor a temperature of an engine and other key assemblies to prevent overheating; a speed sensor including an airspeed head and a GPS module to monitor flight speed and heading in real-time; a fuel quantity sensor to monitor fuel or battery contents in real time to ensure that the aircraft operates in a safe range; a navigation sensor, such as GPS, or GLONASS, to provide location and navigation information; a radar and laser sensor for obstacle detection and avoidance; an optical sensor to monitor the external environment, such as image recognition and visual navigation; and a strain sensor to monitor stress and deformation of the airframe structure to ensure structural safety. When a value measured by an altitude sensor exceeds a certain threshold, or a contact force detected by a load sensor decreases to zero, the control system determines that the aircraft has lifted off the ground.

The mounting positions of the sensors in the aircraft are as follows. The IMU is typically mounted near the center of gravity of the airframe to improve the measurement precision of attitude and motion. The speed sensor (such as an airspeed head) and the barometric pressure sensor are typically mounted on the wings and an empennage to measure the speed and altitude of the aircraft. The barometric pressure sensor and the altitude sensor can be mounted at the bottom of the aircraft to ensure accuracy at different flight altitudes. Drive motors for the tilt-rotors and the propulsion propellers have built-in rotational speed sensors. A tilt actuator angle sensor is mounted on a rotating shaft connecting a fixed end and a rotating end of the actuator.

During vertical take-off and landing phase, the lift provided by the tilt-rotors needs to exceed the aircraft's own weight. For example, if the aircraft's own weight is 1000 kg, the lift needs to be greater than 1000 kg.

In step S1, the control system is composed of a cockpit control apparatus, an on-board computer, the sensors, an tilt-rotor actuator, an tilt-rotor assembly, the propulsion propellers, an aircraft control interface, and necessary mechanical and electrical mechanisms, which is used to control the flight of the aircraft. According to the requirements of manned or unmanned operation, flight control commands are issued by the cockpit control apparatus or the on-board computer. The actuator includes the tilt-rotor actuator, the tilt-rotor assembly, the propulsion propellers, the aircraft control interface, etc. The various sensors, such as the accelerometer, the gyroscope, the airspeed head, and the GPS module, provide control feedback signals to the on-board computer.

In this embodiment, the vertical take-off and landing aircraft is configured with the following factors: a total length of 6 m, a wingspan of 8.8 m and a height of 1.6 m; a maximum take-off weight of 1000 kg, and an empty weight of 700 kg; tilt-rotors composed of 1.6 m-diameter tilt-rotors (two-blade rotors) with a 100 kw drive motor; and propulsion propellers composed of 1.2 m-diameter propulsion propellers (two-blade propellers) with a 70 kw drive motor.

The specific take-off process is as follows.

At step S1, the aircraft prepares for take-off.

The on-board computer performs self-test on the actuator and the sensors, the blades of the tilt-rotors are substantially horizontal to the ground, and the aircraft enters a take-off preparation state.

At step S2, the tilt-rotors are activated with rotational speed gradually increasing.

In this step, the rotational speed of the tilt-rotors gradually increases to generate sufficient lift to lift the aircraft off the ground. This process can be realized by means of a preset rotational speed increase curve. For an aircraft with an estimated take-off weight of 1000 kg, a 100 kw drive motor can be selected to power a 1.6 m-diameter tilt-rotor (two-blade rotor), and when the rotational speed of the tilt-rotor reaches around 2500 rpm, the generated lift enables the aircraft to lift off the ground. The rotational speed of the tilt-rotor is measured by a built-in rotational speed sensor of the drive motor. The rotational speed of the tilt-rotor increases linearly at a 45° angle relative to the time axis.

At step S3, it is determined whether the aircraft leaves the ground.

The flight control system determines a lift-off state of the aircraft by means of feedback from the altitude sensor (such as an altimeter or a barometer) and the load sensor. When a value measured by the altitude sensor exceeds a certain threshold, or a contact force detected by the load sensor decreases to zero, the control system determines that the aircraft has lifted off the ground. Conversely, the control system controls the rotational speed of the tilt-rotors to further increase, enabling the aircraft to obtain more lift until the aircraft leaves the ground. To avoid potential collisions with high-rise buildings on the ground, a threshold of the altitude sensor is typically set at around 200 m.

At step S4, the propulsion propellers are activated with rotational speed gradually increasing.

The flight control system activates the propulsion propellers to provide forward thrust, assisting the aircraft in acceleration. The rotational speed of the propulsion propellers can gradually increases according to a preset curve. For the aircraft with the estimated take-off weight of 1000 kg, a 70 kw drive motor can be selected to power a 1.2 m-diameter propulsion propeller (two-blade propeller). When the rotational speed of the propeller is around 3000 rpm, the generated thrust can cause the aircraft to exceed a stall speed (about 60 km/h). The rotational speed of the propulsion propeller is measured by a built-in rotational speed sensor of the drive motor. The rotational speed of the propulsion propeller increases linearly at a 45° angle relative to the time axis.

At step S5, it is determined whether an airspeed of the aircraft is greater than the stall speed.

The flight control system uses an airspeed sensor (such as a pitot tube or a laser velocimeter) to determine whether the airspeed of the aircraft exceeds the stall speed. When the flight speed exceeds the stall speed, the flight control system determines that the lift generated by the wings is sufficient to support the stable flight of the aircraft. Conversely, the flight control system controls the rotational speed of the propulsion propellers to further increase, enabling the aircraft to further accelerate.

At step S6, the tilt-rotors decelerate.

This step is a key point of the disclosure. After determining, based on feedback from the airspeed sensor, that the flight speed is far from the stall range, the flight control system sends a control command to the drive motor for the tilt-rotors to quickly reduce the rotational speed of the tilt-rotors to a low level (less than 100 rpm) or stop the tilt-rotors, thereby reducing or eliminating the aerodynamic coupling effect between the rotors and the wings/airframe.

At step S7, the tilt-rotors are tilted.

The flight control system controls the tilt-rotor blades to tilt by 90 degrees. Based on a feedback signal from the angle sensor mounted on the tilt actuator, the flight control system ensures that a tilting angle of the tilt-rotors meets the requirements, thereby improving control precision and safety.

At step S8, the rotational speed of the tilt-rotors further increases.

The flight control system controls the rotational speed of the tilt-rotors to further increase to provide additional auxiliary thrust for horizontal flight. The tilt-rotors gradually accelerate to around 80% of the rotational speed in the vertical take-off phase. For the aircraft with the estimated take-off weight of 1000 kg, a cruising speed of the aircraft can increase to 300-400 km/h.

At step S9, the aircraft flies forward.

Based on feedback from the airspeed and attitude sensors, the system can adjust the thrust of the rotors in real time to ensure flight stability and safety.

According to the method for controlling the vertical take-off process of the aircraft according to the above embodiments, the embodiment of the present disclosure further provides a system for controlling a vertical take-off process of an aircraft. The system includes:
an aircraft take-off preparation module, configured such that in an aircraft take-off preparation phase, blades of tilt-rotors are parallel to a horizontal plane, and the tilt-rotors are in a standby state; and when the aircraft is located at a take-off location, a control system enters a ready state, and the aircraft completes all pre-take-off preparation work;
a tilt-rotor activation and rotational speed gradual increase module, configured such that when the aircraft starts to take off, the tilt-rotors are gradually activated, and a rotational speed of the tilt-rotors is gradually increased from a low speed to a speed that generates sufficient lift to lift the aircraft off ground; in this process, rotational speed control of the tilt-rotors is a key parameter, and sensors monitor an aircraft status in real time to enable the rotational speed of the tilt-rotors to adapt to aircraft weight and environmental conditions to provide sufficient vertical lift, and the tilt-rotors are parallel to the horizontal plane, or tilted at a first preset angle relative to the horizontal plane, and the first preset angle ranging from −30° to 30°;
an aircraft lift-off detection module, configured such that when the rotational speed of the tilt-rotors reaches a preset value, the lift generated by the aircraft exceeds the aircraft weight, and the aircraft starts to rise vertically, the sensors for monitoring the aircraft status monitor, whether the aircraft has completely left the ground in real time, and after confirmation of a lift-off state, the aircraft continues to rise at a stable speed;
a propulsion propeller activation and rotational speed gradual increase module, configured such that after the aircraft leaves the ground and rises to a certain altitude, propulsion propellers are activated for gradually increasing a speed of the aircraft in a forward direction to transition the aircraft gradually from a stationary state to a state with a certain flight speed; where increase in the rotational speed of the propulsion propellers is coordinated with a flight altitude of the aircraft, changes in the rotational speed of the tilt-rotors, and overall attitude of the aircraft to ensure stability of a flight attitude of the aircraft;
an aircraft airspeed detection module, configured such that after the propulsion propellers start to provide thrust and the aircraft enters an airspeed monitoring phase, the control system detects an airspeed of the aircraft by the sensors; when the airspeed of the aircraft reaches a set critical value, i.e., greater than a stall speed, the control system proceeds to a next operation, and the aircraft already has obtained a certain flight capability;
a tilt-rotor deceleration module, configured such that after the aircraft reaches a certain airspeed, the control system starts gradually reduces the rotational speed of the tilt-rotors, such that the rotational speed of the tilt-rotors gradually decreases to a preset safe level, ensuring that during upcoming tilting, airflow interference from the tilt-rotors to the aircraft is minimized, effectively avoiding airflow impact on wings and an airframe from high-speed rotation of conventional tilt-rotors, and thus improving flight comfort;
a tilt-rotor tilting module, configured such that after the tilt-rotors decelerate to a specified rotational speed, the tilt rotors start to perform a gradual tilting operation; such that the blades of the tilt-rotors gradually change from being parallel to the horizontal plane to being tilted at a second preset angle relative to a vertical direction of the horizontal plane, the second preset angle ranging from −30° to 30°; and during tilting, the tilt-rotors do no work relative to the aircraft; and by precise angle control and rotational speed adjustment, tilting transition of the tilt-rotors has minimal impact on the overall aerodynamic characteristics of the aircraft, ensuring a stable flight process;
a tilt-rotor rotational speed re-increasing module, configured such that after the tilt-rotors complete tilting, and thus the blades of the tilt-rotors have been tilted to the second preset angle relative to a direction perpendicular to the horizontal plane, function of the tilt-rotors changes from providing vertical lift to auxiliary propulsion; and the control system gradually increases the rotational speed of the tilt-rotors again, enabling the tilt-rotors to work together with the propulsion propellers to provide flight thrust in the forward direction, thereby increasing the flight speed and efficiency of the aircraft; and
an aircraft entering flight mode module, configured such that after the tilt-rotors are re-accelerated to the specified rotational speed, and the aircraft fully enters a flight state, the tilt-rotors and the propulsion propellers jointly function within a propulsion system of the aircraft to provide sufficient flight thrust in the forward direction, enabling the aircraft to travel at a stable speed and altitude, and the sensors continue to monitor the flight state of the aircraft to ensure safety and stability of the aircraft.

The system for controlling the vertical take-off process of the aircraft further includes an auxiliary lift module including a wind energy suction pump and an air storage tank arranged at a bottom of the aircraft, where air is continuously jetted downward through an air jet of the air storage tank to provide lift support for the vertical take-off of the aircraft.

The embodiment of the present disclosure further provides a computer-readable storage medium having a computer program stored thereon. The computer program, when executed by a processor, implements steps of the method for controlling the vertical take-off process of the aircraft according to the above-described embodiments.

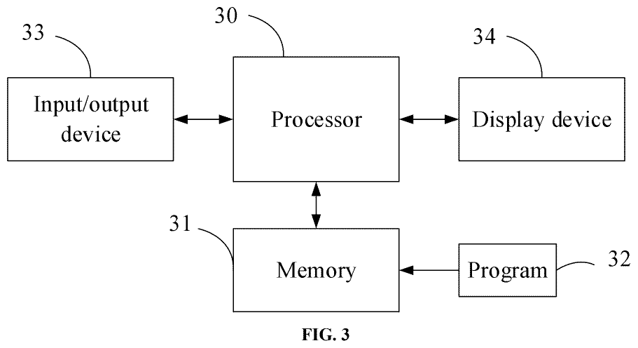

As shown in FIG. 3, a processor 30 executes a computer program 32 to implement the steps of the method for controlling the vertical take-off process of the aircraft according to the above-described embodiments. The processor 30 may be a central processing unit, or other general-purpose processors, digital signal processors, application-specific integrated circuits, off-the-shelf programmable gate arrays or other programmable logic devices, discrete gate or transistor logic devices, discrete hardware assemblies, etc. The general-purpose processor may be a microprocessor or any conventional processor. A memory 31 may be an internal storage unit (such as a hard disk or internal memory) of a server of the system for controlling the vertical take-off process of the aircraft. The memory 31 may also be an external storage device of the server, or a configured plug-in hard disk, smart memory card, secure digital card, flash memory card, etc. Further, the memory 31 may also include both the internal storage unit and the external storage device of the server. The memory 31 is used for storing the computer program, and other programs and data required by an electronic device. The memory 31 may also be used for temporarily storing data that has been output or is to be output. An input/output device 33 may be used for receiving input digital or character information. Specifically, the input/output device 33 may also include, but is not limited to, one or more of a keyboard, a mouse, a joystick, etc. A display device 34 may be used for displaying information input by a user, information provided to the user, and various menus of a terminal. The display device 34 may include a display panel, and optionally can be a liquid crystal display.

In summary, although the present disclosure has been disclosed above with preferred embodiments, these preferred embodiments are not intended to limit the present disclosure. Those of ordinary skill in the art can make various modifications and refinements without departing from the spirit and scope of the present disclosure. Therefore, the protection scope of the present disclosure should be subject to the scope defined by the claims.

What is claimed is:

1. A method for controlling a vertical take-off process of an aircraft, comprising:
step S1: provision of an aircraft, wherein a control system and sensors for monitoring an aircraft status in real time are provided in the aircraft, and propulsion propellers and a plurality of tilt-rotors are provided on the aircraft; and
aircraft take-off preparation, wherein, in an aircraft take-off preparation phase, blades of the tilt-rotors are parallel to a horizontal plane, and the tilt-rotors are in a standby state; and when the aircraft is located at a take-off location, the control system enters a ready state, and the aircraft completes all pre-take-off preparation work;
step S2: tilt-rotor activation with rotational speed gradually increasing, wherein, when the aircraft starts to take off, the tilt-rotors are gradually activated, and a rotational speed of the tilt-rotors is gradually increased from a low speed to a speed that generates sufficient lift to lift the aircraft off ground; in this process, rotational speed control of the tilt-rotors is a key parameter, and the sensors monitor the aircraft status in real time to enable the rotational speed of the tilt-rotors to adapt to aircraft weight and environmental conditions to provide sufficient vertical lift, and the tilt-rotors are parallel to the horizontal plane, or tilted at a first preset angle relative to the horizontal plane;
step S3: aircraft lift-off detection, wherein when the rotational speed of the tilt-rotors reaches a preset value, the lift generated by the aircraft exceeds the aircraft weight, and the aircraft starts to rise vertically, the sensors for monitoring the aircraft status monitor whether the aircraft has completely left the ground in real time, and after confirmation of a lift-off state, the aircraft continues to rise at a stable speed;
step S4: propulsion propeller activation with rotational speed gradually increasing, wherein, after the aircraft leaves the ground and rises to a certain altitude, the propulsion propellers are activated for gradually increasing a speed of the aircraft in a forward direction to transition the aircraft gradually from a stationary state to a state with a certain flight speed; wherein increase in the rotational speed of the propulsion propellers is coordinated with a flight altitude of the aircraft, changes in the rotational speed of the tilt-rotors, and overall attitude of the aircraft to ensure stability of a flight attitude of the aircraft;
step S5: aircraft airspeed detection, wherein, after the propulsion propellers start to provide thrust, the aircraft enters an airspeed monitoring phase; the control system detects an airspeed of the aircraft by the sensors; when the airspeed of the aircraft reaches a set critical value, i.e., greater than a stall speed, the control system proceeds to a next operation, and the aircraft already has obtained a certain flight capability;
step S6: tilt-rotor deceleration, wherein after the aircraft reaches a certain airspeed, the control system starts to gradually reduce the rotational speed of the tilt-rotors, such that the rotational speed of the tilt-rotors gradually decreases to a preset safe level, ensuring that during upcoming tilting, airflow interference from the tilt-rotors to the aircraft is minimized, effectively avoiding airflow impact on wings and an airframe from high-speed rotation of conventional tilt-rotors, and thus improving flight comfort;
step S7: tilt-rotor tilting, wherein, after the tilt-rotors decelerate to a specified rotational speed, the tilt rotors start to perform a gradual tilting operation, such that the blades of the tilt-rotors gradually change from being parallel to the horizontal plane to being tilted at a second preset angle relative to a vertical direction of the horizontal plane; and during tilting, the tilt-rotors do no work relative to the aircraft; and by precise angle control and rotational speed adjustment, tilting transition of the tilt-rotors has minimal impact on the overall aerodynamic characteristics of the aircraft, ensuring a stable flight process;
step S8: further increase in tilt-rotor rotational speed, wherein after the tilt-rotors complete tilting, and thus the blades of the tilt-rotors have been tilted to the second preset angle relative to a direction perpendicular to the horizontal plane, function of the tilt-rotors changes from providing vertical lift to auxiliary propulsion; and the control system gradually increases the rotational speed of the tilt-rotors again, enabling the tilt-rotors to work together with the propulsion propellers to provide flight thrust in the forward direction, thereby increasing the flight speed and efficiency of the aircraft; and
step S9: aircraft entering a flight mode, wherein after the tilt-rotors are re-accelerated to the specified rotational speed, the aircraft fully enters a flight state, the tilt-rotors and the propulsion propellers jointly function within a propulsion system of the aircraft to provide sufficient flight thrust in the forward direction, enabling the aircraft to travel at a stable speed and altitude, and the sensors continue to monitor the flight state of the aircraft to ensure safety and stability of the aircraft.

2. The method for controlling the vertical take-off process of the aircraft according to claim 1, wherein in step S1, an on-board computer performs self-test on an actuator and the sensors, the sensors comprising: an inertial measurement unit, a barometric pressure sensor, a temperature sensor, a speed sensor, a fuel quantity sensor, a navigation sensor, a radar and laser sensor, an optical sensor, a strain sensor, an altitude sensor, and a load sensor.

3. The method for controlling the vertical take-off process of the aircraft according to claim 1, wherein in step S2, the rotational speed of each tilt-rotor is measured by a built-in rotational speed sensor of a drive motor, the rotational speed of the tilt-rotor gradually increases according to a preset curve, and the first preset angle ranges from −30° to 30°.

4. The method for controlling the vertical take-off process of the aircraft according to claim 1, wherein in step S3, the control system determines the lift-off state of the aircraft by feedback from an altitude sensor and a load sensor, and when a value measured by the altitude sensor exceeds a certain threshold, or a contact force detected by the load sensor decreases to zero, the control system determines that the aircraft has lifted off the ground; conversely, the control system controls the rotational speed of the tilt-rotors to further increase, enabling the aircraft to obtain more lift until the aircraft leaves the ground.

5. The method for controlling the vertical take-off process of the aircraft according to claim 1, wherein in step S4, the rotational speed of the propulsion propellers gradually increases according to a preset curve.

6. The method for controlling the vertical take-off process of the aircraft according to claim 1, wherein in step S4, during the propulsion propeller activation with rotational speed gradually increasing, the propulsion propellers are activated before the aircraft leaves the ground.

7. The method for controlling the vertical take-off process of the aircraft according to claim 1, wherein in step S7, the second preset angle ranges from −30° to 30°, and in step S9, when the aircraft enters a horizontal flight mode, the aircraft flies forward relying solely on power of the tilt-rotors or the propulsion propellers.

8. The method for controlling the vertical take-off process of the aircraft according to claim 1, wherein step S3 further comprises: providing a wind energy suction pump and an air storage tank at a bottom of the aircraft, wherein air is continuously jetted downward through an air jet of the air storage tank to provide lift support for the vertical take-off of the aircraft.

9. A system for controlling a vertical take-off process of an aircraft, comprising:
an aircraft take-off preparation module, configured such that in an aircraft take-off preparation phase, blades of tilt-rotors are parallel to a horizontal plane, and the tilt-rotors are in a standby state; and when the aircraft is located at a take-off location, a control system enters a ready state, and the aircraft completes all pre-take-off preparation work;
a tilt-rotor activation and rotational speed gradual increase module, configured such that when the aircraft starts to take off, the tilt-rotors are gradually activated, and a rotational speed of the tilt-rotors is gradually increased from a low speed to a speed that generates sufficient lift to lift the aircraft off ground; in this process, rotational speed control of the tilt-rotors is a key parameter, and sensors monitor an aircraft status in real time to enable the rotational speed of the tilt-rotors to adapt to aircraft weight and environmental conditions to provide sufficient vertical lift, and the tilt-rotors are parallel to the horizontal plane, or tilted at a first preset angle relative to the horizontal plane, and the first preset angle ranging from −30° to 30°;
an aircraft lift-off detection module, configured such that when the rotational speed of the tilt-rotors reaches a preset value, the lift generated by the aircraft exceeds the aircraft weight, and the aircraft starts to rise vertically, the sensors for monitoring the aircraft status monitor, whether the aircraft has completely left the ground in real time, and after confirmation of a lift-off state, the aircraft continues to rise at a stable speed;
a propulsion propeller activation and rotational speed gradual increase module, configured such that after the aircraft leaves the ground and rises to a certain altitude, propulsion propellers are activated for gradually increasing a speed of the aircraft in a forward direction to transition the aircraft gradually from a stationary state to a state with a certain flight speed; wherein increase in the rotational speed of the propulsion propellers is coordinated with a flight altitude of the aircraft, changes in the rotational speed of the tilt-rotors, and overall attitude of the aircraft to ensure stability of a flight attitude of the aircraft;
an aircraft airspeed detection module, configured such that after the propulsion propellers start to provide thrust and the aircraft enters an airspeed monitoring phase, the control system detects an airspeed of the aircraft by the sensors; when the airspeed of the aircraft reaches a set critical value, i.e., greater than a stall speed, the control system proceeds to a next operation, and the aircraft already has obtained a certain flight capability;
a tilt-rotor deceleration module, configured such that after the aircraft reaches a certain airspeed, the control system starts gradually reduces the rotational speed of the tilt-rotors, such that the rotational speed of the tilt-rotors gradually decreases to a preset safe level, ensuring that during upcoming tilting, airflow interference from the tilt-rotors to the aircraft is minimized, effectively avoiding airflow impact on wings and an airframe from high-speed rotation of conventional tilt-rotors, and thus improving flight comfort;
a tilt-rotor tilting module, configured such that after the tilt-rotors decelerate to a specified rotational speed, the tilt rotors start to perform a gradual tilting operation; such that the blades of the tilt-rotors gradually change from being parallel to the horizontal plane to being tilted at a second preset angle relative to a vertical direction of the horizontal plane, the second preset angle ranging from −30° to 30°; and during tilting, the tilt-rotors do no work relative to the aircraft; and by precise angle control and rotational speed adjustment, tilting transition of the tilt-rotors has minimal impact on the overall aerodynamic characteristics of the aircraft, ensuring a stable flight process;
a tilt-rotor rotational speed re-increasing module, configured such that after the tilt-rotors complete tilting, and thus the blades of the tilt-rotors have been tilted to the second preset angle relative to a direction perpendicular to the horizontal plane, function of the tilt-rotors changes from providing vertical lift to auxiliary propulsion; and the control system gradually increases the rotational speed of the tilt-rotors again, enabling the tilt-rotors to work together with the propulsion propellers to provide flight thrust in the forward direction, thereby increasing the flight speed and efficiency of the aircraft; and
an aircraft entering flight mode module, configured such that after the tilt-rotors are re-accelerated to the specified rotational speed, and the aircraft fully enters a flight state, the tilt-rotors and the propulsion propellers jointly function within a propulsion system of the aircraft to provide sufficient flight thrust in the forward direction, enabling the aircraft to travel at a stable speed and altitude, and the sensors continue to monitor the flight state of the aircraft to ensure safety and stability of the aircraft.

10. A computer-readable storage medium having a computer program stored thereon, wherein the computer program, when executed by a processor, implements steps of the method for controlling the vertical take-off process of the aircraft according to claim1.

11. The computer-readable storage medium according to claim 10, wherein in step S1, an on-board computer performs self-test on an actuator and the sensors, the sensors comprising: an inertial measurement unit, a barometric pressure sensor, a temperature sensor, a speed sensor, a fuel quantity sensor, a navigation sensor, a radar and laser sensor, an optical sensor, a strain sensor, an altitude sensor, and a load sensor.

12. The computer-readable storage medium according to claim 10, wherein in step S2, the rotational speed of each tilt-rotor is measured by a built-in rotational speed sensor of a drive motor, the rotational speed of the tilt-rotor gradually increases according to a preset curve, and the first preset angle ranges from −30° to 30°.

13. The computer-readable storage medium according to claim 10, wherein in step S3, the control system determines the lift-off state of the aircraft by feedback from an altitude sensor and a load sensor, and when a value measured by the altitude sensor exceeds a certain threshold, or a contact force detected by the load sensor decreases to zero, the control system determines that the aircraft has lifted off the ground; conversely, the control system controls the rotational speed of the tilt-rotors to further increase, enabling the aircraft to obtain more lift until the aircraft leaves the ground.

14. The computer-readable storage medium according to claim 10, wherein in step S4, the rotational speed of the propulsion propellers gradually increases according to a preset curve.

15. The computer-readable storage medium according to claim 10, wherein in step S4, during the propulsion propeller activation with rotational speed gradually increasing, the propulsion propellers are activated before the aircraft leaves the ground.

16. The computer-readable storage medium according to claim 10, wherein in step S7, the second preset angle ranges from −30° to 30°, and in step S9, when the aircraft enters a horizontal flight mode, the aircraft flies forward relying solely on power of the tilt-rotors or the propulsion propellers.

17. The computer-readable storage medium according to claim 10, wherein step S3 further comprises: providing a wind energy suction pump and an air storage tank at a bottom of the aircraft, wherein air is continuously jetted downward through an air jet of the air storage tank to provide lift support for the vertical take-off of the aircraft.
